(19) United States
(12) Patent Application Publication
(10) Pub. No.: US 2022/0383299 A1
(43) Pub. Date: Dec. 1, 2022

(54) INTELLECTUAL PROPERTY AND FINANCIAL DISTRIBUTION MANAGEMENT USING DISTRIBUTED LEDGERS

(71) Applicant: Kyodai Technologies Inc. d/b/a/ Rensa Games, Cheyenne, WY (US)

(72) Inventors: Anthony J. Apollo, Cheyenne, WY (US); Frank M. Apollo, Cheyenne, WY (US); Nicholas C. Apollo, Cheyenne, WY (US)

(21) Appl. No.: 17/824,081

(22) Filed: May 25, 2022

Related U.S. Application Data
(60) Provisional application No. 63/194,493, filed on May 28, 2021.

(51) Int. Cl. G06Q 20/36

(52) U.S. Cl. CPC G06Q 20/3678; G06Q 2220/00

(57) ABSTRACT

Systems and methods for managing intellectual property and financial distributions associated with digital objects using distributed ledgers are provided. A digital object marketplace receives a request to obtain a license token for a digital object. License tokens for the digital object are generated by a smart contract deployed in a distributed ledger. The digital object is also associated with an owner token generated when the digital object is published to the digital object marketplace, or with a recipient digital wallet. The digital object marketplace, using the smart contract, transfers a payment from a requestor's digital wallet to the holder of the owner token or to the recipient digital wallet and the transfer is recorded in the distributed ledger. A license token for the digital object is provided to the requestor's digital wallet and the transaction associated with the license token is further recorded in the distributed ledger.

### CROSS-REFERENCE TO RELATED APPLICATIONS

The present patent application claims the priority benefit of U.S. provisional patent application No. 63/194,493 filed May 28, 2021, the disclosure of which are incorporated by reference herein.

### FIELD

The present disclosure relates generally to systems and methods for managing intellectual property and financial distributions (e.g., revenue sharing, royalties, etc.) associated with digital objects using distributed ledgers.

### BACKGROUND

The global market for digital media (e.g., video games, digital images, digital video, digital audio, etc.) has expanded substantially over time. For instance, the global video game market has grown to $174.9 billion annually, with publishers and development companies posting record profits. However, these substantial gains have come at the expense of the content creators that produce the myriad digital objects that are used to create the digital media published by these publishers and development companies. Further, creation of new digital media can require multidisciplinary teams, long hours, and significant capital. This may serve as barriers to small-scale creation of digital media, which, in turn, allow incumbent publishers and large development entities to monopolize talent and technology. As a result, content creators are often forced to forfeit true ownership of their work (i.e., intellectual property) and any financial (e.g., revenue sharing, royalties, etc.) or reputational upside that an independent effort could garner them. Additionally, creativity and innovation amongst content creators is stifled by the demands of these publishers and development companies.

### SUMMARY

Disclosed embodiments provide a framework for a digital object marketplace that may leverage smart contracts and distributed ledgers to manage intellectual property and financial distributions (e.g., revenue sharing, royalties, etc.) associated with digital objects published to the digital object marketplace. Through the digital object marketplace, content creators and independent developers can list and monetize their digital objects via license tokens, which can be leveraged to build new digital objects in a collaborative manner. These digital objects can include character models, motion capture files, audio recordings, software development kits, other forms of digital media, and the like. The digital object marketplace may function as a peer-to-peer (P2P) exchange backed by a distributed ledger and managed using smart contracts or tokens specific to the digital objects published therein. As content creators and independent developers utilize digital objects from the digital object marketplace to generate new digital objects, the smart contracts specific to these digital objects may be leveraged to facilitate real-time financial distributions for the licensing and sale of digital objects, thereby ensuring that all associated content creators and developers are properly compensated for their contributions.

According to some embodiments, a computer-implemented method is provided. The computer-implemented method comprises receiving a request to obtain a license token for a digital object. License tokens for the digital object are generated by a smart contract deployed in a distributed ledger. Further, the digital object is associated with an owner token or a designated digital wallet address. The method further includes transferring a payment from a digital wallet associated with the request to a holder of the owner token or owner of the designated digital wallet corresponding to the designated digital wallet address. This payment is transferred by the smart contract and is recorded in the distributed ledger. The method further includes providing the license token for the digital object to the digital wallet associated with the request. A transaction providing the license token to the digital wallet associated with the request is also recorded in the distributed ledger.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

This summary is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The foregoing, together with other features and examples, will be described in more detail below in the following specification, claims, and accompanying drawings.

### BRIEF DESCRIPTION OF THE DRAWINGS

The present disclosure is described in conjunction with the appended Figures:

FIG. 1 shows an illustrative example of an environment in which various embodiments can be implemented;

FIG. 2 shows an illustrative example of an environment in which digital objects published to a digital object marketplace can be licensed to various licensees using a decentralized distributed ledger in accordance with at least one embodiment;

FIG. 3 shows an illustrative example of an environment in which a smart contract is used to issue license tokens to licensees for a digital object and to issue corresponding payments to content creators in accordance with at least one embodiment;

FIG. 4 shows an illustrative example of a browser application through which a user can submit a request to obtain a license token for a digital object in accordance with at least one embodiment;

FIG. 5 shows an illustrative example of a browser application through which a user can publish a digital object and define a price using a cryptocurrency for the digital object in accordance with at least one embodiment;

FIG. 6 shows an illustrative example of a process for publishing a new digital object and establishing a smart contract in a distributed ledger for licensing of the new digital object in accordance with at least one embodiment;

FIG. 7 shows an illustrative example of a process for issuing a license token for a digital object and automatically distributing payment to corresponding content creators using a smart contract in accordance with at least one embodiment; and

FIG. 8 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

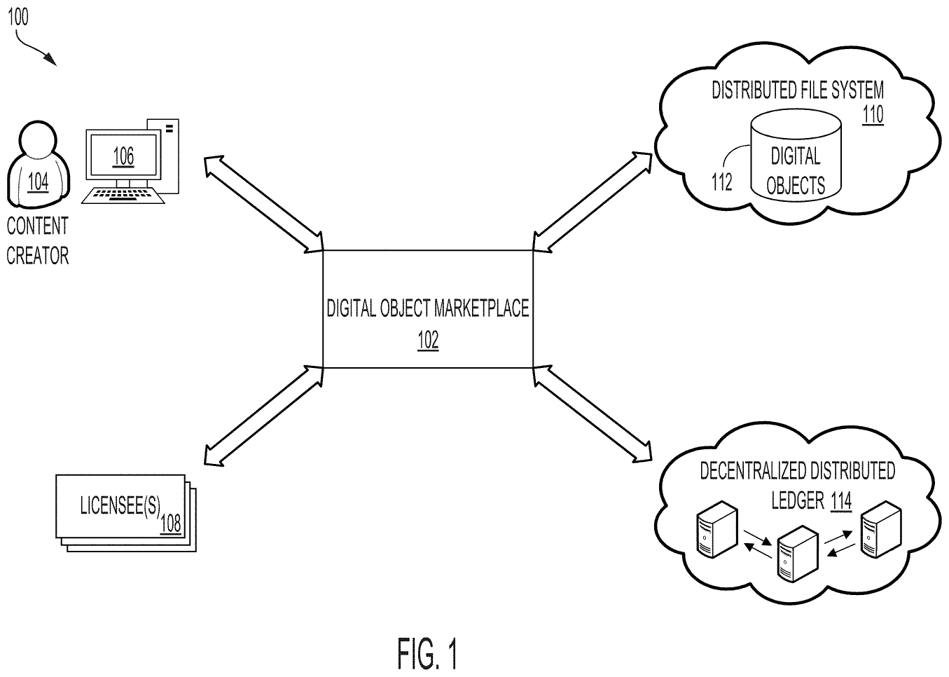

FIG. 1 shows an illustrative example of an environment 100 in which various embodiments can be implemented. In the environment 100, a content creator 104, using a computing device 106 (e.g., desktop computer, laptop computer, tablet computer, smartphone, etc.) may submit a request to a digital object marketplace 102 to publish a digital object and to establish one or more parameters for licensing of the digital object to licensees 108 through the digital object marketplace 102. The digital object marketplace 102 may be an open peer-to-peer (P2P) digital exchange, through which independent content creators (such as content creator 104) may list and monetize their digital objects via tokenized licenses. Licensees 108 may purchase a tokenized license for a digital object from the digital object marketplace 102 and, accordingly, leverage this digital object to develop new digital media in a collaborative manner. The digital object marketplace 102 may be implemented as a digital platform, utilizing computer systems and applications as a backend to manage digital objects on behalf of content creators, designate recipient digital wallets or furnish owner tokens to content creators 104 upon digital object upload, furnish tokenized licenses to licensees 108 upon purchase, and distribute corresponding payments to content creators automatically and in real-time using a decentralized distributed ledger 114.

In an embodiment, through the digital object marketplace 102, a content creator 104 can upload a digital object and define one or more parameters for making the digital object available to licensees 108. For instance, a content creator 104 may define a price for purchasing a tokenized license that may denote a licensee's authorization to utilize the digital object. For instance, a licensee 108 being provided with a tokenized license to a particular digital object published to the digital object marketplace 102 may access the digital object via the digital object marketplace 102 and utilize the digital object for its own projects, subject to any policies defined by the content creator 104. As an illustrative example, a content creator 104 may seek to publish a set of digital animations that it has recorded for various fight scenes. A licensee 108, in turn, may need such digital animations for a new video game that it is developing. Thus, the licensee 108 may access the digital object marketplace 102 to request a tokenized license to the digital animations published by the content creator 104.

The one or more parameters for making the digital object available to licensees 108 may include a price for purchase of a tokenized license to the digital object, financial distribution terms for purchases of any digital media that uses the digital object as a component, terms or policies for how the digital object may be used by licensees 108, the number of tokenized licenses that may be generated and issues for the digital object, and the like. In an embodiment, a content creator 104, via the digital object marketplace 102, can define a bonding curve, which may be used by the digital object marketplace 102 to automatically, and in real-time, adjust the price for a tokenized license based on the supply of available tokenized licenses for the digital object. For example, a content creator 104 may define a linear bonding curve, whereby the price for a tokenized license to its digital object may increase linearly as tokenized licenses are purchased by licensees 108. Alternatively, a content creator 104 may define an exponential or polynomial bonding curve, whereby the price of the tokenized license may increase according to the exponential or polynomial function, respectively, utilized to generate the bonding curve. The use of a bonding curve may be optional, such that a content creator 104 may simply define a fixed price for a tokenized license to its digital object.

In an embodiment, a content creator 104 can define individual licensing terms for specific licensees 108 seeking to purchase a tokenized license for its digital object. For example, a content creator 104, via the digital object marketplace 102, may define specific financial distribution terms for different licensees 108, whereby a certain licensee may be subject to higher financial distribution requirements compared to other licensees. In some instances, the content creator 104 may define one or more formulas by which financial distribution terms may be automatically defined based on the upfront payment made by a licensee to purchase a tokenized license for a digital object. For example, if a licensee 108 submits an upfront payment amount for the tokenized license, the digital object marketplace 102, using the formula defined by the content creator 104, may automatically determine the financial distribution terms for the digital object, whereby the financial distributions required may increase at a rate inversely proportional to the upfront payment amount for the tokenized license.

In an embodiment, the digital object marketplace 102 can require each user to link a digital wallet to the digital object marketplace 102. The digital wallet may be required for the management of tokenized licenses, processing of payments for tokenized licenses, and to receive automated payments associated with the purchase of tokenized licenses by licensees 108 and with financial distributions earned as a result of the sale of tokenized licenses corresponding to digital media that includes a digital objects subject to pre-defined financial distribution terms. In an embodiment, the digital wallet is a software-based cryptocurrency wallet that is used to interact with a decentralized distributed ledger 114. The digital wallet may be made accessible via a browser extension application executed when a user accesses a corresponding browser application on their computing device. In an embodiment, when a user (e.g., content creator 104, licensee 108, etc.) accesses the digital object marketplace 102 utilizing its browser application, the digital object marketplace 102 may attempt to access the browser extension application for authentication of the user and to link the user's account within the digital object marketplace 102 with its digital wallet.

The decentralized distributed ledger 114 may be a decentralized database managed by various members across multiple nodes. This decentralized database may be shared, replicated, and synchronized amongst these various members within a decentralized network. These members within the decentralized network may govern and agree by consensus on updates to the records in the distributed ledger 114. The decentralized distributed ledger 114 is, thus, decentralized by virtue of having no central authority or mediator involved in the governance of the distributed ledger. Each record that is maintained in the decentralized distributed ledger 114 may have a timestamp and unique cryptographic signature, which may be used to audit the distributed ledger 114 and to provide a comprehensive history of transactions within the decentralized network. As contemplated herein, any type of decentralized distributed ledger 114 may be used that supports the creation and implementation of smart contracts and for the recording of transactions and financial distributions amongst users of the digital object marketplace 102. Thus, the decentralized distributed ledger 114 may include a public or private blockchain, Hashgraph, Directed Acyclic Graph (DAG), Holochain, Radix Tempo, and the like.

In an embodiment, the digital object marketplace 102 can require a content creator 104 to define a price and financial distribution terms for the digital object that is to be published using units of a cryptocurrency. For instance, as illustrated substantially herein, the digital object marketplace 102 may prompt a content creator 104 to specify an amount of ether, or ETH (if the decentralized distributed ledger 114 is implemented using the Ethereum blockchain), required to purchase a tokenized license for the digital object. Further, if the content creator 104 defines one or more financial distribution terms for its digital object, the digital object marketplace 102 may require the content creator 104 to define these financial distribution terms using units of a cryptocurrency, as well. In some embodiments, the digital object marketplace 102 can further allow a content creator 102 to define the price and financial distribution terms for the digital object using a fiat currency (e.g., United States Dollar, Euro, Yen, etc.). If the content creator 104 defines the price and financial distribution terms for the digital object using a fiat currency, the digital object marketplace 102 may automatically convert the specified fiat currency amounts into corresponding units of a cryptocurrency associated with the decentralized distributed ledger 114 in real-time when transactions are performed. For instance, when a licensee opts to purchase a tokenized license for a digital object, the digital object marketplace 102 may, real-time, determine an exchange rate between the fiat currency used to define the price of the tokenized license and the cryptocurrency associated with the decentralized distributed ledger 114. The conversion may be presented to the licensee, which may allow the licensee to determine whether to proceed with the transaction.

In an embodiment, once the content creator 104 has defined the purchase price and any applicable financial distribution terms for the digital object that the content creator 104 wishes to publish to the digital object marketplace 102, the digital object marketplace 102 may map the purchase price and any applicable financial terms to a smart contract. A smart contract may be a collection of programmatic code and data that may reside at a specific address on the decentralized distributed ledger 114. The smart contract may serve as a type of account within the decentralized distributed ledger 114, whereby the smart contract may have a balance and may transmit transactions over the decentralized network. The smart contract may be deployed to the decentralized network of the decentralized distributed ledger 114 and may function as programmed by the digital object marketplace 102. The digital object marketplace 102 may interact with the smart contract by submitting transactions on behalf of users that execute one or more functions defined in the smart contract. This may include distributing tokenized licenses to users, distributing payment to the owner of the digital object associated with the smart contract (e.g., content creator 104), and the like.

In an embodiment, the digital object marketplace 102 deploys a platform smart contract to the decentralized distributed ledger 114 that can generate, or mint, owner tokens and license tokens for each digital object published to the digital object marketplace 102. For instance, the platform smart contract may distribute owner tokens and license tokens to users of the digital object marketplace 102 for each digital object published to the digital object marketplace 102. Each token may have a unique identifier (e.g., a unique unsigned integer, etc.) and any payments resulting from license purchases and/or financial distribution terms for digital objects published to the digital object marketplace 102 can be processed by the platform smart contract according to token metadata or a distribution contract.

A distribution contract may define a one-to-one relationship between each object owner token and the financial distribution terms for each contributor associated with the digital object. The object owner token, in an embodiment, stores the addresses of the digital wallets associated with the contributors associated with the object owner token. In some instances, a contributor may be any entity that contributed to the creation of the underlying digital object, including other digital objects, other media, or computer code that may be compiled to form the digital object. In an embodiment, when a payment is transmitted to the distribution contract, each contributor associated with the distribution contract may automatically receive a portion of the payment according to the previously defined financial distribution terms.

In addition to deploying a smart contract for the digital object to the decentralized distributed ledger 114, the digital object marketplace 102 may further store the digital object in a digital object store 112 within a distributed file system 110. The distributed file system 110 may rely on cryptographic hashes that can be stored in a distributed ledger, such as decentralized distributed ledger 114. The distributed file system 110 may utilize content-addressing to uniquely identify each digital object stored in the digital object store 112 using a global namespace connecting various devices within the decentralized network. Similar to the decentralized distributed ledger 114, the distributed file system 110 may be implemented using a decentralized network of operators that may maintain portions of the overall data. A user of the distributed file system 110 may serve a digital object by its corresponding content address, allowing other users in the network to find and request the digital object from any node that maintains the digital object using a distributed hash table. Examples of distributed file systems include InterPlanetary File System (IPFS), Arweave, Storj, Filecoin, Sun Microsystems® Network File System (NFS), Microsoft® Distributed File System, IBM® Distributed File Service (DFS), Amazon® Simple Storage Service (S3), and the like.

When the smart contract corresponding to the published digital object is deployed to the decentralized distributed ledger 114, the smart contract may generate an object owner token that designates the content creator 104 as the originator of the digital object. The object owner token may be issued and held by the content creator 104 in its digital wallet and recorded in the decentralized distributed ledger 114. In an embodiment, the object owner token is transferrable to other users of the digital object marketplace 102. For instance, a content creator 104 can sell the object owner token to another user at an agreed upon price. The transaction may be processed using the decentralized distributed ledger 114 and recorded therein. The other user, now the holder of the object owner token, may automatically, and in real-time, receive any payments generated through the sale of tokenized licenses associated with the digital object and any financial distributions generated by the tokenized licenses linked to the object owner token, as described herein.

In an embodiment, the smart contract corresponding to the published digital object is a distribution contract (as described above) that designates a specific digital wallet address (e.g., a recipient digital wallet) as the recipient of any payments generated through the sale of tokenized licenses associated with the digital object and any financial distributions generated by the tokenized licenses associated with the published digital object. The smart contract, in some instances, may be modified to designate a different recipient digital wallet. This modification to the smart contract may have a similar effect to that resulting from the transfer of the aforementioned object token to another user, whereby the newly designated recipient digital wallet may automatically, and in real-time, receive any payments generated through the sale of tokenized licenses and any financial distributions generated by these tokenized licenses.

In addition to generating an object owner token or designating a recipient digital wallet, the smart contract may also generate the aforementioned tokenized licenses (also referred to herein as “object license tokens”) for the digital object. The object license tokens may be generated automatically when the smart contract is deployed to the decentralized distributed ledger 114 and provided to the digital wallet owned and maintained by the digital object marketplace 102 on behalf of the content creator 104. When a licensee 108 purchases a license to the digital object via the digital object marketplace 102, the digital object marketplace 102 may automatically transfer an object license token from its digital wallet to the digital wallet of the licensee 108. This transaction may be recorded in the decentralized distributed ledger 114. In an embodiment, an object license token can be generated at the point-of-sale (e.g., when the licensee 108 submits a request to purchase a license to the digital object) by the smart contract and automatically transferred to the licensee's digital wallet.

In an embodiment, the digital object marketplace 102 provides a platform through which an independent developer (e.g., another content creator, a licensee, etc.) may generate digital media via a media development environment. Through the digital object marketplace 102, the independent developer may upload digital objects and access any licensed digital objects for use in the media development environment to generate new digital media (e.g., video games, digital images, digital video, digital audio, etc.). In an embodiment, when the independent developer ports a digital object represented by an object license token into their media development environment, the digital object marketplace 102 may refer to the independent developer's digital wallet (such as through the browser extension application tied to the decentralized distributed ledger 114 and the address corresponding to the independent developer's digital wallet) to determine whether the independent developer has the requisite object license token for the digital object. If the digital object marketplace 102 determines that the independent developer has the requisite object license token for the digital object, the digital object marketplace 102 may further determine whether the independent developer may utilize the digital object for the new digital media being developed in the media development environment. For instance, when creating the media development environment for the new digital media, the independent developer may be required to define one or more attributes of the new digital media (e.g., genre, expected rating (Entertainment Software Rating Board (ESRB) rating, Pan European Game Information (PEGI) rating, etc.), etc.). Based on these attributes, and any policies defined in the object license token for use of the digital object, the digital object marketplace 102 may determine whether the digital object may be used by the independent developer for the new digital media being developed. This may allow content creators to manage how their digital objects are utilized by licensees 108.

In an embodiment, when a licensee 108 publishes digital media that includes the digital object published by the content creator 104 via the digital object marketplace 102, the digital media may be added to the digital object store 112 of the distributed file system 110. Further, the digital object marketplace 102 may deploy a new smart contract for the digital media to the decentralized distributed ledger 114. The new smart contract may generate a media owner token that designates the licensee 108 as the originator and owner of the published digital media. The smart contract may provide the media owner token to the digital wallet owned and maintained by the licensee 108.

In an embodiment, instead of issuing a media owner token to the licensee 108, the smart contract can designate a particular digital wallet as a recipient digital wallet for any financial distributions associated with the published digital media. The smart contract may be modified to designate a different digital wallet for any financial distributions associated with the published digital media, for instance, when a licensee 108 wishes to transfer their interest in the digital media to another entity (e.g., another licensee, etc.). This modification to the smart contract may have a similar effect to that resulting from the transfer of the media owner token to another entity, whereby the newly designated recipient digital wallet may automatically, and in real-time, receive any financial distributions generated through the sale of the published digital media.

Similar to the process for generating the smart contract for a digital object, a licensee 108, via the digital object marketplace 102, may define one or more parameters for licensing of the digital media. For instance, the licensee 108 may define a purchase price for the digital media, the number of available media license tokens that may be generated for the digital media, and the like. In addition to these one or more parameters, the licensee 108 may further define one or more transfer restrictions for a media license token, including a minimum transfer value, which may set a floor for the amount that an entity purchasing a media license token for the digital media may resell the media license token to other entities for. This may allow the licensee 108 to preserve revenues and financial distribution flows in the event that a media license token is transferred (e.g., sold) to another entity in the future. Other transfer restrictions may include, but are not limited to, blocking transfers of the media license token during a designated period of time following the initial sale, limiting the number of transfers that can made for a specific token, limiting the digital wallets that can participate in a transfer, and other such examples.

In addition to generating the media owner token, the smart contract may generate media license tokens. The media license tokens may be generated automatically when the smart contract is deployed to the decentralized distributed ledger 114 and provided to the digital wallet owned and maintained by the digital object marketplace 102 on behalf of the licensee 108 (e.g., the independent developer). When a user purchases a license to the media object via the digital object marketplace 102, the digital object marketplace 102 may automatically transfer a media license token from its digital wallet to the digital wallet of the user. This transaction may be recorded in the decentralized distributed ledger 114. In an embodiment, a media license token can be generated at the point-of-sale (e.g., when a user submits a request to purchase a license to the digital media published by the independent developer) by the smart contract and automatically transferred to the user's digital wallet. The user, using the provided media license token, may access the digital media through the digital object marketplace 102. For instance, when the user accesses a landing page for the digital media within the digital object marketplace 102, the digital object marketplace 102 may determine whether the user has the corresponding media license token in its digital wallet. If so, the digital object marketplace 102 may allow the user to access the digital media.

When a user purchases a media license token via the digital object marketplace 102, the user's payment may be processed using the smart contract deployed in the decentralized distributed ledger 114 to facilitate financial distributions to the independent developer and any content creators whose digital objects are incorporated in the digital media. As an illustrative example, if the purchase price for a media license token is $50, the smart contract may process the transaction and distribute a $40 payment (converted into a corresponding cryptocurrency) to the holder of the media owner token or owner of the designated recipient digital wallet for the digital media, $8.50 to the holder(s) of the object owner token(s) or owner(s) of the recipient digital wallet(s) corresponding to the digital object(s) incorporated into the digital media, and $1.50 to the digital object marketplace 102 as a transaction fee. The currency or percentage amounts that are distributed to the digital media owner, the digital object owner(s), and to the digital object marketplace 102 may be governed by the agreed-upon terms defined in each associated smart contract (e.g., smart contract for the digital media, smart contract(s) for any included digital object(s) used in the creation of the digital media, etc.). It should be noted that the smart contracts described herein may each include a legally-binding contract facilitated through a distributed ledger-based protocol for the creation and execution of legal agreements, such as OpenLaw™ or Monax™.

The media owner token may also be transferrable to other users of the digital object marketplace 102. For instance, a licensee 108 can sell its media owner token to another user at an agreed upon price. The transaction may be processed using the decentralized distributed ledger 114 and recorded therein. The other user, now the holder of the media owner token, may automatically, and in real-time, receive any payments generated through the sale of media license tokens associated with the digital media and linked to the media owner token, as described herein. Alternatively, if the smart contract designates a recipient digital wallet for any financial distributions resulting from the sale of the media license tokens associated with the digital media, the smart contract may be modified to designate a different recipient digital wallet. This would result in any subsequent financial distributions resulting from the sale of the media license tokens associated with the digital media being automatically, and in real-time, added to the newly designated recipient digital wallet.

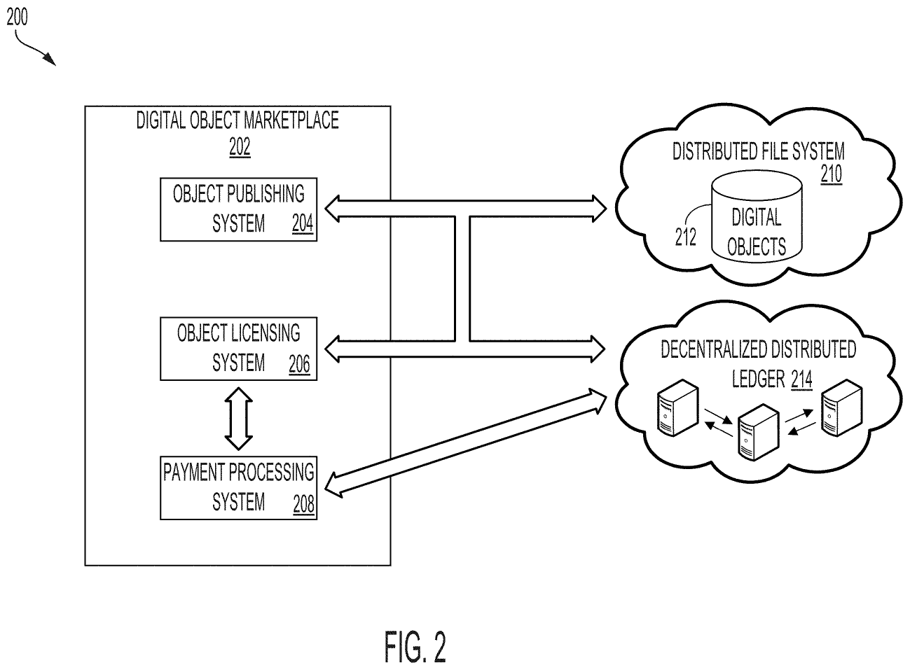

FIG. 2 shows an illustrative example of an environment 200 in which digital objects published to a digital object marketplace 202 can be licensed to various licensees using a decentralized distributed ledger 214 in accordance with at least one embodiment. In the environment 200, the digital object marketplace 202 includes an object publishing system 204, which may allow users of the digital object marketplace 202, such as content creators and independent developers, to publish their digital objects to the digital object marketplace 202. The object publishing system 204 may be implemented using a computer system of the digital object marketplace 202 or as an application or code executing on one or more computer systems of the digital object marketplace 202.

In an embodiment, the digital object marketplace 202, through the object publishing system 204, provides users with an interface and platform through which users can publish their digital objects. For instance, a content creator or independent developer can utilize the object publishing system 204 to upload a digital object and define one or more parameters (e.g., purchase price, financial distribution terms, terms or policies for use of the digital object, number of license tokens to be made available, any price bonding curves, etc.) for making the digital object available to purchasers via the digital object marketplace 202. For instance, a content creator or independent developer may define a price for purchasing an object licensing token or media licensing token that may denote a purchaser's authorization to utilize the digital object. For instance, a purchaser of an object license token for a particular digital object published to the digital object marketplace 202 may access the digital object via the digital object marketplace 202 and utilize the digital object for its own projects, subject to any policies defined by the content creator or independent developer.

Once a content creator or independent developer has published a digital object to the object publishing system 204 and has provided corresponding licensing parameters for the digital object, the object publishing system 204 may store the digital object in a digital object store 212 of a distributed file system 210. As noted above, the distributed file system 210 may rely on cryptographic hashes that can be stored in a distributed ledger, such as decentralized distributed ledger 214. The distributed file system 210 may utilize content-addressing to uniquely identify each digital object stored in the digital object store 212 using a global namespace connecting various devices within the decentralized network. Similar to the decentralized distributed ledger 214, the distributed file system 210 may be implemented using a decentralized network of operators that may maintain portions of the overall data. A user of the distributed file system 210 may serve a digital object by its corresponding content address, allowing other users in the network to find and request the digital object from any node that maintains the digital object using a distributed hash table.

In addition to storing the digital object using the distributed file system 210, the object publishing system 204 may map the purchase price and any applicable financial distribution terms to a smart contract corresponding to the digital object. The smart contract, as noted above, may be deployed to the decentralized distributed ledger 214, where the smart contract may reside at a specific address on the decentralized distributed ledger 214. The smart contract may serve as a type of account within the decentralized distributed ledger 214, whereby the smart contract may have a balance and may transmit transactions over a decentralized network. Further, the smart contract may function as programmed by the object publishing system 204. For instance, when users interact with an object licensing system 206 to obtain an object license token for the digital object, as described in greater detail herein, the object licensing system 206 may interact with the smart contract by submitting transactions on behalf of users that execute one or more functions defined in the smart contract.

When the smart contract corresponding to the published digital object is deployed to the decentralized distributed ledger 214, the smart contract may generate an object owner token that designates the content creator or independent developer as the originator of the digital object. Alternatively, the smart contract may designate a recipient digital wallet that is associated with the originator of the digital object. If the smart contract is implemented to generate an object owner token, the generated object owner token may be issued and held by the content creator or independent developer in its digital wallet and recorded in the decentralized distributed ledger 214. As noted above, the object owner token may be transferrable to other users of the digital object marketplace 202. Transfers of the object owner token may be processed using the decentralized distributed ledger 214 and recorded therein. The other user, now the holder of the object owner token, may automatically, and in real-time, receive any payments generated through the sale of tokenized licenses associated with the digital object and any other financial distributions generated by the object license tokens linked to the object owner token.

If the smart contract is implemented to designate a particular recipient digital wallet that is associated with the published digital object, an address corresponding to the recipient digital wallet may be recorded in the decentralized distributed ledger 214. As noted above, the smart contract may be modified to change the recipient digital wallet. This change may be recorded in the decentralized distributed ledger 214 such that any payments generated through the sale of tokenized licenses associated with the digital object and any other financial distributions generated by the object license tokens linked to the recipient digital wallet are automatically, and in real-time, deposited into the recipient digital wallet.

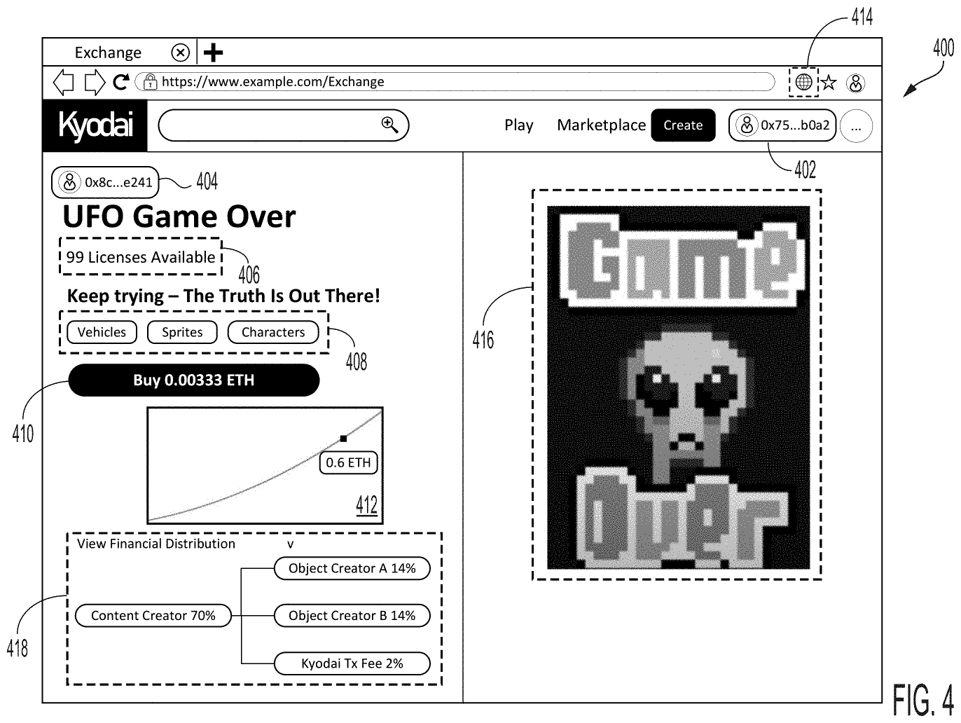

The smart contract deployed to the decentralized distributed ledger 214 may further generate one or more object license tokens that may be made available for licensing of the digital object. The object license tokens may be generated automatically when the smart contract is deployed to the decentralized distributed ledger 214 and provided to a digital wallet owned and maintained by an object licensing system 206 of the digital object marketplace 202 on behalf of the content creator or independent developer (e.g., holder of the object owner token or owner of the recipient digital wallet indicated in the smart contract). The object licensing system 206 may be implemented using a computer system of the digital object marketplace 202 or as an application or code executing on one or more computer systems of the digital object marketplace 202. The object licensing system 206 may provide users with an interface and platform through which users can submit requests to purchase a digital object from the digital object marketplace 202. For instance, through the interface, a user may identify any available digital objects for purchase and submit requests to purchase a license for any of these available digital objects. An illustrative example of this interface is described in greater detail herein in connection with FIG. 4.

In an embodiment, when a user accesses the object licensing system 206 and submits a request to purchase a license to a digital object, the object licensing system 206 may automatically transfer an object license token from its digital wallet to the digital wallet of the user. This transaction may be recorded in the decentralized distributed ledger 214. In an embodiment, an object license token can be generated at the point-of-sale (e.g., when the user submits a request to purchase a license to the digital object through the interface provided by the object licensing system 206) by the smart contract and automatically transferred to the user's digital wallet in real-time.

In an embodiment, when a user submits a request to the object licensing system 206 to purchase an object license token for a digital object, the object licensing system 206 may transmit a payment request to a payment processing system 208 of the digital object marketplace 202 for processing and distribution of the user's payment to the content creator of independent contractor according to the terms specified in the smart contract. The payment processing system 208 may be implemented using a computer system of the digital object marketplace 202 or as an application or code executing on one or more computer systems of the digital object marketplace 202. The payment processing system 208 may transmit the transaction request, the address of the recipient digital wallet or digital wallet address holding the object owner token, and an identity token corresponding to the purchaser's digital wallet to the smart contract for the digital object deployed in the decentralized distributed ledger 214 for processing of the transaction. The smart contract, in response, may transfer the payment to the content creator's or independent developer's digital wallet from the purchaser's digital wallet and record the transaction in the decentralized distributed ledger 214. Further, the smart contract may transfer an object license token to the purchaser's digital wallet.

When a user attempts to access a digital object via the object licensing system 206, the object licensing system 206 may query the user's digital wallet to determine whether the user has an object license token required to access the digital object. If the object licensing system 206 determines that the user does not have the required object license token for accessing the digital object, the object licensing system 206 may prompt the user to purchase an object license token at a specified price (as set by the content creator or independent developer). However, if the object licensing system 206 determines that the user has the requisite object license token for the digital object, the object licensing system 206 may allow the user to access the digital object according to any access control defined in the object license token.

In an embodiment, a content creator or independent developer can further interact with the object publishing system 204 to publish digital media created using one or more digital objects licensed through the object licensing system 206. For instance, the object publishing system 204 may provide users with a media development environment through which these users may access their own digital objects and any digital objects licensed through the object licensing system 206 to generate new digital media. For instance, through the object publishing system 204, a content creator or independent developer may upload digital objects and access any licensed digital objects for use in the media development environment to generate and publish new digital media (e.g., video games, digital images, digital video, digital audio, etc.). When a content creator or independent developer ports a digital object represented by an object license token into their media development environment, the object publishing system 204 may refer to the content creator's or independent developer's digital wallet to determine whether the content creator or independent developer has the requisite object license token for the digital object. If the object publishing system 204 determines that the content creator or independent developer has the requisite object license token for the digital object, the object publishing system 204 may further determine whether the digital object may be used for the new digital media being developed in the media development environment. For instance, when creating the media development environment for the new digital media, a content creator or independent developer may be required to define one or more attributes of the new digital media. Based on these attributes, and any policies defined in the object license token for use of the digital object, the object publishing system 204 may determine whether the digital object may be used for the new digital media being developed.

Similar to the publishing of a digital object, the object publishing system 204 may publish newly created digital media to the digital object store 212 of the distributed file system 210. Further, the object publishing system 204 may deploy a new smart contract for the digital media to the decentralized distributed ledger 214. The new smart contract may generate a media owner token that designates the content creator or independent developer that published the digital media as the originator and owner of the digital media. Alternatively, the new smart contract may designate the digital wallet associated with the content creator or independent developer as the recipient digital wallet. If the smart contract generates a media owner token for the published digital media, the smart contract may provide the media owner token to the digital wallet owned and maintained by the content creator or independent developer. Further, if the digital media was created using one or more digital objects associated with object license tokens issued to the content creator or independent creator, the object publishing system 204 may refer to these object license tokens in the smart contract. This may allow the smart contract to identify the distribution schema for financial distributions to other content creators or independent developers that may be owners (e.g., holders of corresponding object owner tokens, owners of corresponding recipient digital wallets, etc.) of the digital objects used to create the digital media.

A content creator or independent developer publishing digital media via the object publishing system 204 may also define one or more parameters for licensing of the digital media. For instance, the content creator or independent developer may define a purchase price for the digital media, the number of available media license tokens that may be generated for the digital media, and the like. In addition to these one or more parameters, the content creator or independent developer may further define a minimum transfer value of a media license token, which may set a floor for the amount that an entity purchasing a media license token for the digital media may resell the media license token to other entities for. This may allow the content creator or independent developer to preserve revenues and financial distribution flows in the event that a media license token is transferred to another entity in the future. Additionally, or alternatively, the content creator or independent developer may set other transfer restrictions for the media license token (e.g., blocking transfers of the media license token during a designated period of time following the initial sale, etc.).

The smart contract for the digital media deployed in the decentralized distributed ledger 214 may generate media license tokens that may be purchased in order to gain access to the digital media. The media license tokens may be generated automatically when the smart contract is deployed to the decentralized distributed ledger 214 and provided to the digital wallet owned and maintained by the object licensing system 206 on behalf of the content creator or independent developer. When a user purchases a license to the media object via the object licensing system 206, the object licensing system 206 may automatically transfer a media license token from its digital wallet to the digital wallet of the user. This transaction may be recorded in the decentralized distributed ledger 214. In an embodiment, a media license token can be generated at the point-of-sale by the smart contract and automatically transferred to the user's digital wallet. The user, using the provided media license token, may access the digital media through the object licensing system 206. For instance, when the user accesses a landing page for the digital media within the object licensing system 206, the object licensing system 206 may determine whether the user has the corresponding media license token in its digital wallet. If so, the object licensing system 206 may allow the user to access the digital media.

In an embodiment, when a user submits a request to purchase a media license token for digital media via the object licensing system 206, the object licensing system 206 may transmit a payment request to the payment processing system 208 for processing and distribution of the user's payment to the content creator or independent contractor that holds the media owner token or that owns the recipient digital wallet designated in the smart contract, as well as to any other content creators or independent developers that hold object owner tokens for digital objects used in the creation of the digital media or that own the recipient digital wallets designated in the smart contracts corresponding to these digital objects. The distribution of the payment may be performed according to the terms specified in the smart contract (e.g., financial distribution terms for digital objects, transactions fees, etc.). The payment processing system 208 may transmit the transaction request, the media owner token held by the content creator or independent developer or the address of the recipient digital wallet owned by the content creator or independent developer, and an identity token corresponding to the purchaser's digital wallet to the smart contract for the digital media deployed in the decentralized distributed ledger 214 for processing of the transaction. The smart contract, in response, may distribute the payment among the content creator's or independent developer's digital wallet, the digital wallet for the digital object marketplace 202, and the digital wallet(s) of any content creators or independent developers whose digital objects were utilized in the creation of the digital media, subject to any applicable financial distribution terms. The payment may be distributed from the purchaser's digital wallet and the transaction may be recorded in the decentralized distributed ledger 214. Further, the smart contract may transfer a media license token to the purchaser's digital wallet.

As noted above, the media owner token issued to the content creator or independent developer may also be transferrable to other users of the digital object marketplace 202. For instance, a content creator or independent developer can sell its media owner token to another user at an agreed upon price. The transaction may be processed by the object licensing system 204 using the decentralized distributed ledger 214 and recorded therein. The other user, now the holder of the media owner token, may automatically, and in real-time, receive any payments generated through the sale of media license tokens associated with the digital media and linked to the media owner token, as described herein. Similarly, object owner tokens may be transferrable to other users of the digital object marketplace 202. The new holders of these object owner tokens may be entitled to payments related to the purchase of corresponding object licensing tokens and to any financial distributions owed as a result of incorporation of the underlying digital objects into new digital media.

If the smart contract associated with the digital media is implemented to designate a particular recipient digital wallet, the smart contract may be modified to change the recipient digital wallet. This change may be recorded in the decentralized distributed ledger 214 such that any payments generated through the sale of media license tokens associated with the digital media are automatically, and in real-time, deposited into the newly designated recipient digital wallet.

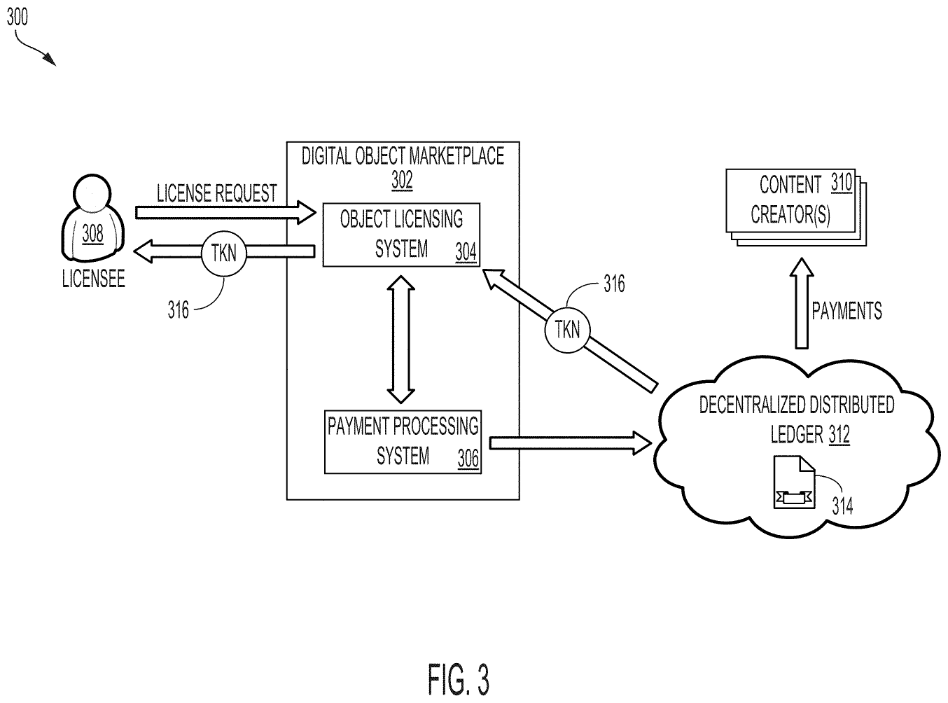

FIG. 3 shows an illustrative example of an environment 300 in which a smart contract 314 is used to issue license tokens 316 to licensees (such as licensee 308) for a digital object and to issue corresponding payments to content creators in accordance with at least one embodiment. In the environment 300, a licensee 308 may submit a license request to an object licensing system 304 of the digital object marketplace 302 to obtain an object license token 316 for a particular digital object. The object licensing system 304 may be similar to the object licensing system 206 described above in connection with FIG. 2. The license request submitted by the licensee 308 may be subject to an agreed-upon purchase price indicated by the object licensing system 304 via an interface provided by the object licensing system 304. As noted above, the object licensing system 304 may provide users with an interface and platform through which users can submit requests to purchase a digital object from the digital object marketplace 302. For instance, through the interface, a user may identify any available digital objects for purchase and submit requests to purchase a license for any of these available digital objects.

In response to the request from the licensee 308 to purchase an object license token 316 for a corresponding digital object, the object licensing system 304 may provide, to the payment processing system 306, a payment request for processing and distribution of the licensee's payment to a content creator 310, another holder of an object owner token for the digital object, or to the owner of the recipient digital wallet indicated in the smart contract associated with the digital object. The payment processing system 306, based on an identifier corresponding to the content creator 310, other holder of an object owner token, or owner of the recipient digital wallet provided by the object licensing system 304, may access the content of the digital wallet of the creator or other holder of the object owner token to obtain the object owner token. Alternatively, if the smart contract associated with the digital object indicates a recipient digital wallet, the payment processing system 306 may access the recipient digital wallet. Further, the payment processing system 306 may access the licensee's digital wallet to obtain an identity token corresponding to the licensee 308. The payment transaction system 306 may provide the object owner token or recipient digital wallet address, the licensee's identity token, and the transaction request to the smart contract 314 deployed to the decentralized distributed ledger 312.

In response to the transaction request, the smart contract 314 may transfer the corresponding payment from the licensee's 308 digital wallet to a digital wallet corresponding to the content creator 310 or other holder of the object owner token or to the recipient digital wallet indicated in the smart contract associated with the digital object. This payment transfer may be recorded by the smart contract 314 into the decentralized distributed ledger 312. Additionally, the smart contract 314 may generate, or mint, an object license token 316 that may be issued to the licensee 308. The smart contract 314 may provide the object license token 316 to the object licensing system 304 which, in turn, may add the object license token 316 to the licensee's digital wallet. In some instances, rather than providing the object license token 316 to the object licensing system 304, the smart contract 314 may automatically add the object license token 316 to the licensee's digital wallet.

In an embodiment, as opposed to minting a new object license token 316 in response to a transaction request, the smart contract 314 for the digital object can generate one or more object license tokens that may be made available for licensing of the digital object. These object license tokens may be generated automatically when the smart contract 314 is deployed to the decentralized distributed ledger 312 and provided to a digital wallet owned and maintained by an object licensing system 304 of the digital object marketplace 302 on behalf of the content creator or independent developer (e.g., holder of the object owner token, owner of a designated recipient digital wallet, etc.). Once the payment transaction has been completed (e.g., payment has been transferred to the digital wallet of the holder of the object owner token or to the recipient digital wallet indicated in the smart contract associated with the digital object), the smart contract 314 may transmit a notification to the object licensing system 304 indicating that the payment from the licensee 308 has been processed. This may cause the object licensing system 304 to transfer an object license token 316 from its digital wallet to the licensee's digital wallet, fulfilling the license request.

FIG. 4 shows an illustrative example of a browser application 400 through which a user can submit a request to obtain an object license token for a digital object in accordance with at least one embodiment. As noted above, the digital object marketplace may provide an interface, such as through a website or web portal, through which users may submit requests to purchase licenses to digital objects and digital media and to access said digital objects and digital media. As illustrated in FIG. 4, a user of the digital object marketplace may access a landing page for a particular digital object that may be available for purchase. The landing page may provide various details corresponding to the digital object. For example, the landing page may specify a descriptive title and description of the digital object. Further, the landing page may provide an identifier 404 corresponding to the holder of the object owner token for the digital object or to the owner of the recipient digital wallet associated with the digital object. As noted above, when a digital object is published to the digital object marketplace, a smart contract corresponding to the digital object may be deployed to a decentralized distributed ledger. This smart contract may issue an object owner token to the content creator of the digital object and added to the content creator's digital wallet. Alternatively, this smart contract may indicate an address corresponding to a recipient digital wallet associated with the content creator of the digital object. The identifier 404 corresponding to the holder of the object owner token for the digital object may correspond to the cryptographic hash for the digital wallet of the holder of the object owner token. Alternatively, the identifier 404 may correspond to the public address of the designated recipient digital wallet.

The landing page may further specify the number of available object license tokens 406 for the digital object (if defined by the content creator). As noted above, a content creator or independent developer publishing a digital object via the object publishing system of the digital object marketplace may also define one or more parameters for licensing of the digital object. For instance, the content creator or independent developer may define a purchase price for the digital object, the number of available object license tokens 406 that may be generated for the digital object, and the like. These one or more parameters may be added to the smart contract for the digital object, which may be accessed by the digital object marketplace to determine the number of available object license tokens 406 in real-time.

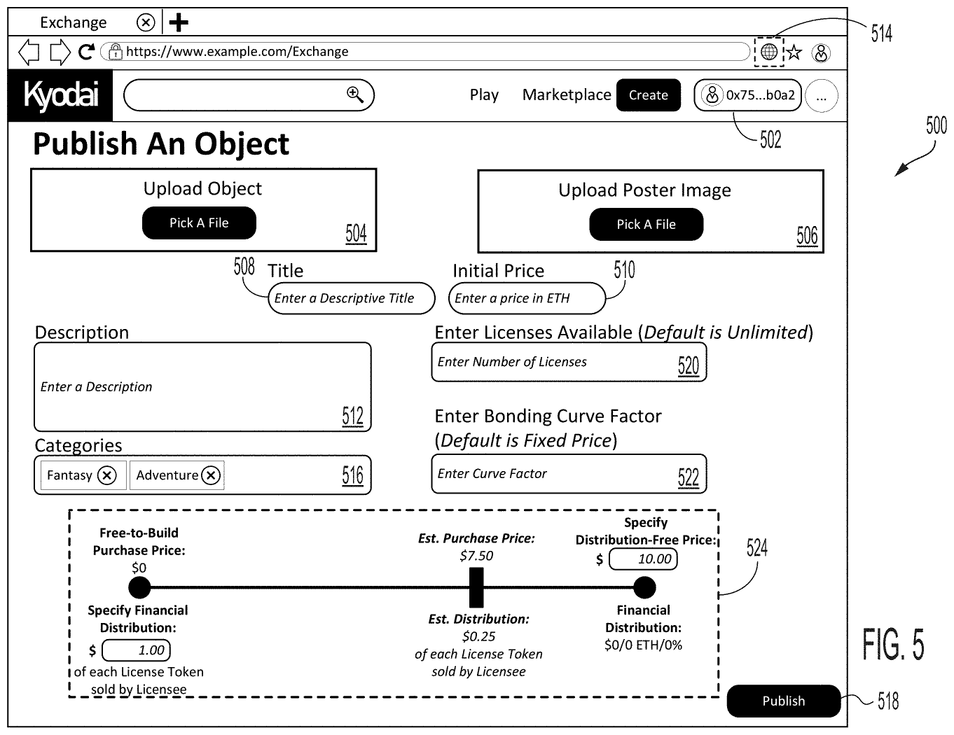

In addition to providing the number of available object license tokens 406, the digital object marketplace may present, via the landing page, one or more categories 408 for the digital object. As described in greater detail herein in connection with FIG. 5, a content creator may select one or more categories 408 for its digital object. These one or more categories 408 may be used to describe one or more characteristics of the digital object. Further, the one or more categories 408 may be used as keywords for the digital object. As an illustrative example, if a user of the digital object marketplace submits a query for “vehicle sprites,” the digital object marketplace may determine that the digital object illustrated in FIG. 4 is associated with the keywords “vehicles” and “sprites” and present digital objects (including the digital object illustrated in FIG. 4) associated with these search terms to the user via the interface.

The digital object marketplace may provide, via the landing page, a purchase button 410 that may specify the purchase price for the digital object and, when selected, may be used to submit a request to the digital object marketplace to purchase an object license token for the digital object. The purchase price displayed within the purchase button 410 may correspond to the purchase price set by the content creator when publishing the digital object to the digital object marketplace. The purchase price may be denoted using units of a cryptocurrency associated with the decentralized distributed ledger utilized by the digital object marketplace. As an illustrative example, the digital object marketplace may prompt a content creator to specify an amount of ether, or ETH (if the decentralized distributed ledger is implemented using the Ethereum blockchain), required to purchase an object license token for the digital object. The amount of ETH specified by the content creator may be displayed within the purchase button 410 (e.g., 0.00333 ETH, as illustrated in FIG. 4). As noted above, the digital object marketplace can allow a content creator to define the price for the digital object using a fiat currency. If the content creator defines the price for the digital object using a fiat currency, the digital object marketplace may automatically convert the specified fiat currency amounts into corresponding units of a cryptocurrency associated with the decentralized distributed ledger in real-time and present this cryptocurrency price via the purchase button 410. For instance, when a licensee opts to purchase a tokenized license for a digital object, the digital object marketplace may, in real-time, determine an exchange rate between the fiat currency used to define the price of the object license token and the cryptocurrency associated with the decentralized distributed ledger. The conversion may be presented to the user via the purchase button 410, which may allow the user to determine whether to proceed with the transaction.

As noted above, a content creator, via the digital object marketplace, can define a bonding curve 412, which may be used by the digital object marketplace to automatically, and in real-time, adjust the price for an object license token based on the number of available object license tokens 406 for the digital object. For example, a content creator may define a linear bonding curve, whereby the price for an object license token may increase linearly as the number of object license tokens 406 decreases. Alternatively, a content creator may define an exponential or polynomial bonding curve, whereby the price of the object license token may increase according to the exponential or polynomial function, respectively, utilized to generate the bonding curve 412. The use of a bonding curve 412 may be optional, such that a content creator may simply define a fixed price for an object license token. Thus, if the content creator foregoes creation of a bonding curve for dynamically determining the price of an object license token, the digital object marketplace may forego displaying a bonding curve 412.

The digital object marketplace, via the landing page, may further provide a graphical representation of the digital object 416. The graphical representation of the digital object 416 may allow a user to evaluate the digital object prior to submitting a request to purchase an object license token for the digital object. The graphical representation of the digital object 416 may be provided by the content creator when publishing the digital object to the digital object marketplace. Alternatively, the digital object marketplace may automatically evaluate the published digital object to identify any images or other graphical elements that may be used to generate the graphical representation of the digital object 416 that may be presented via the landing page.

In an embodiment, if payments for the digital object are subject to a financial distribution schema, the digital object marketplace, via the landing page, can further provide a graphical representation of the financial distribution 418 for the digital object. For instance, as illustrated in FIG. 4, the graphical representation of the financial distribution 418 for the digital object may specify that the content creator of the digital object is entitled to 70% of the purchase price, whereas each of object creators A-B may be entitled to 14% of the purchase price and the digital object marketplace may be entitled to 2% of the purchase price as a transaction fee. The graphical representation of the financial distribution 418 may provide an identifier for the content creator, as well as for each of the other object creators that may be entitled to financial distributions resulting from the sale of a license token for the digital object. Thus, a user may readily determine who will receive any proceeds from the sale of the license token and determine whether to proceed with a request to purchase a license token for the digital object.

In an embodiment, in order to purchase an object license token, the user may be required to link a digital wallet to the digital object marketplace. The digital wallet may be required for the management of object licensing tokens, processing of payments for object licensing tokens, and to receive automated payments associated with the purchase of object licensing tokens by licensees and with financial distributions earned as a result of the sale of object licensing tokens corresponding to digital media that includes digital objects subject to pre-defined financial distribution terms. In an embodiment, the digital wallet is a software-based cryptocurrency wallet that is used to interact with a decentralized distributed ledger. The digital wallet may be made accessible via a browser extension application 414 executed when a user accesses a corresponding browser application 400 on their computing device. In an embodiment, when a user (e.g., content creator, licensee, etc.) accesses the digital object marketplace utilizing its browser application 400, the digital object marketplace may attempt to access the browser extension application 414 for authentication of the user and to link the user's account within the digital object marketplace with its digital wallet. The identifier of the digital wallet may be presented on the landing page, such as through identifier 402.

It should be noted that while browser extension applications are described extensively throughout the present disclosure for the purpose of illustration, a user's digital wallet may be implemented using a hardware wallet, such as the Ledger® Nano S. A hardware wallet may store a user's private cryptographic keys on a secure hardware device. Thus, the hardware wallet may provide a level of isolation between the user's cryptographic keys and their other computing devices. The hardware wallet may be used in conjunction with a software application companion, which may provide a bridge between the hardware wallet and the digital object marketplace, allowing the digital object marketplace to interact with the hardware wallet to authenticate the user and to link the user's account with the hardware wallet. This link may facilitate the transactions described and contemplated herein.

FIG. 5 shows an illustrative example of a browser application 500 through which a user can publish a digital object and define a price using a cryptocurrency for the digital object in accordance with at least one embodiment. As noted above, the digital object marketplace may provide an interface, such as through a website or web portal, through which users may submit a request to publish a digital object to the digital object marketplace. As illustrated in FIG. 5, a user of the digital object marketplace may access a landing page for publishing a new digital object. The landing page may provide various elements that may be used to upload a new digital object and to provide one or more parameters for making the digital object available to potential licensees. For example, the landing page may provide an upload object interface 504, through which a user may select a digital object that may be available to potential licensees via the digital object marketplace. For instance, through selection of a file selection button within the upload object interface 504, the user may access its file system within its computing device and select one or more files that may serve as the digital object that is to be made available for licensing and use through the digital object marketplace.

In addition to the upload object interface 504, the digital object marketplace may provide, via the landing page, an upload poster image interface 506. Through the upload poster image interface 506, a user may select a poster image that may be used to create a graphical representation of the digital object being made available through the digital object marketplace. For instance, if the user selects a file selection button within the upload poster image interface 506, the user may access its file system within its computing device and select an image file corresponding to the digital object that is to be published and that may serve as a graphical representation of the digital object. As illustrated in FIG. 4, the digital object marketplace may provide this graphical representation of the digital object to allow a user to evaluate the digital object prior to submitting a request to purchase an object license token for the digital object. It should be noted that in some embodiments, the digital object marketplace can automatically determine a poster image that may be used as a graphical representation of the digital image. For instance, in an embodiment, the digital object marketplace can automatically evaluate an uploaded digital object to identify any images or other graphical elements that may be used to generate the graphical representation of the digital object that may be presented to potential licensees. In some instances, the digital object marketplace may present an identified image or other graphical element identified by the digital object marketplace to the content creator to allow the content creator to determine whether the identified image or other graphical element should be used as the graphical representation of the digital object.

The digital object marketplace can further provide, via the landing page, a title input field 508, through which the user (e.g., content creator) may provide a descriptive title for the digital object that is to be published. The descriptive title provided by a user may be presented to potential licensees via the landing page for the digital object. For example, as illustrated in FIG. 4, the descriptive title for the digital object, “UFO Game Over,” may be prominently displayed to potential licensees and actual licensees of the digital object to allow these users to readily determine the title for the digital object.

The landing page for publishing of a digital object can include a price definition field 510, through which a user may define a price for the digital object. The digital object marketplace, via the price definition field 510, may require the user to define a price using units of a particular cryptocurrency utilized by the decentralized distributed ledger described above. For instance, as illustrated in FIG. 5, the user may be required to enter a price for the digital object using ether, or ETH, for the Ethereum blockchain. In some embodiments, the digital object marketplace can further allow a content creator to define the price for the digital object in the price definition field 510 using a fiat currency (e.g., United States Dollar, Euro, Yen, etc.). As noted above, if the content creator defines the price for the digital object using a fiat currency, the digital object marketplace may automatically convert the specified fiat currency amount into corresponding units of a cryptocurrency associated with the decentralized distributed ledger in real-time when transactions are performed. For instance, when a licensee opts to purchase an object license token for the digital object, the digital object marketplace may, in real-time, determine an exchange rate between the fiat currency used to define the price of the object license token for the digital object and the cryptocurrency associated with the decentralized distributed ledger. The conversion may be presented to the licensee, which may allow the licensee to determine whether to proceed with the transaction.

In an embodiment, the digital object marketplace allows the user to define, via the landing page and a licenses number field 520, a set number of available object license tokens for the digital object. Further, via the landing page, the user may define a bonding curve that can be used to dynamically determine the price of an object license token for the digital object according to the number of remaining available object license tokens. For instance, as illustrated in FIG. 5, the user may utilize a bonding curve field 522 to provide a curve factor that may be used to define a bonding curve according to the curve factor and the initial price entered into the price definition field 510. For example, a content creator may define a curve factor corresponding to a linear bonding curve, whereby the price for an object license token to its digital object may increase linearly as object license tokens are purchased by licensees. Alternatively, a content creator may define a curve factor corresponding to an exponential or polynomial bonding curve, whereby the price of the object license token may increase according to the exponential or polynomial function, respectively, utilized to generate the bonding curve. The use of a bonding curve may be optional, such that a content creator may simply define a fixed price for an object license token to its digital object through the price definition field 510 without providing a curve factor within the bonding curve field 522.

In addition to defining the price for licensing of its digital object, a content creator can further define, via the landing page, one or more financial distribution terms for use of the digital object within new digital media. For example, a content creator, via the landing page for publishing a digital object to the digital object marketplace, may define specific financial distribution terms for different licensees, whereby a certain licensee may be subject to higher financial distribution requirements compared to other licensees. In an embodiment, the digital object marketplace provides, via the landing page, a financial distribution term definition slider 524 through which a user may define any applicable financial distribution terms for the digital object that is to be published. For instance, as illustrated in FIG. 5, the user may define, via the financial distribution term definition slider 524, a financial distribution payment or term corresponding to a “free-to-build” option, whereby a licensee may provide no upfront payment for the digital object but may instead be subject to a financial distribution payment or term, as defined by the user, for each license token sold by the licensee for a new digital object that incorporates the digital object being published by the user. Additionally, the user may define, via the financial distribution term definition slider 524, a financial distribution-free purchase price for the digital object, whereby the licensee may purchase a license token without being subject to any financial distribution terms. Based on the values specified by the user, the digital object marketplace, via the financial distribution term definition slider 524, may allow the user to determine, in real-time, the financial distribution terms for a potential licensee based on the upfront purchase price provided by the potential licensee for a license token. For instance, as the user moves the slider towards the “free-to-build” option, the estimated purchase price may decrease and the estimated financial distribution terms or price of each license token sold by the licensee for a derivative digital object may increase proportionately. Thus, the user may readily determine, via the financial distribution term definition slider 524, what financial distribution terms may be applicable based on an upfront purchase price provided by a licensee and adjust any of the provided values accordingly.

It should be noted that while a financial distribution term definition slider 524 is illustrated in FIG. 5, the digital object marketplace may provide other interface elements that may be used by the user to define possible financial distribution terms for the digital object. For example, the content creator may define one or more formulas by which financial distribution terms may be automatically defined based on the upfront payment made by a licensee to purchase an object license token for a digital object. For example, if a licensee submits an upfront payment amount for the object license token, the digital object marketplace, using the formula defined by the content creator, may automatically determine the financial distribution terms for the digital object, whereby the financial distribution payments required may increase at a rate inversely proportional to the upfront payment amount for the object license token. Alternatively, the user may define a fixed purchase price and/or fixed financial distribution terms for the digital object, whereby each potential licensee may be required to provide a fixed upfront payment and agree to fixed financial distribution terms for a license token.

The digital object marketplace, via the landing page illustrated in FIG. 5, may further require the content creator to provide a description of the digital object via a description input field 512 and to provide one or more categories for the digital object using a categories input field 516. Through the description input field 512, the content creator may provide a description of its digital object that may be used to entice potential licensees into purchasing an object license token for the digital object. As noted above and as illustrated in FIG. 4, the digital object marketplace may present, via a landing page for the digital object used to make the digital object available for purchase, one or more categories 408 for the digital object. Through the categories input field 516, a content creator may select one or more categories for its digital object. These one or more categories may be used to describe one or more characteristics of the digital object. Further, the one or more categories may be used as keywords for the digital object. As an illustrative example, if a user of the digital object marketplace submits a query for “fantasy” and/or “adventure” (e.g., the categories selected and illustrated in FIG. 5) the digital object marketplace may determine that the digital object is associated with the keywords “fantasy” and “adventure” and present digital objects (including the digital object that is to be published) associated with these searches to the user via the interface.

Once the content creator has uploaded a digital object and has defined the one or more parameters (e.g., purchase price, financial distribution terms, number of license tokens to be made available, any price bonding curves, etc.) for making the digital object available to purchasers via the digital object marketplace, the content creator may select a publish object button 518 to submit a request to the digital object marketplace to publish the digital object. In response to selection of the publish object button 518, the digital object marketplace may map the purchase price and financial distribution terms to a smart contract. The smart contract may serve as a type of account within the decentralized distributed ledger, whereby the smart contract may have a balance and may transmit transactions over the decentralized network. The smart contract may be deployed to the decentralized network of the decentralized distributed ledger and may function as programmed by the digital object marketplace. The digital object marketplace may interact with the smart contract by submitting transactions on behalf of users that execute one or more functions defined in the smart contract. This may include distributing tokenized licenses to users, distributing payment to the owner of the digital object associated with the smart contract (e.g., content creator), and the like.

As noted above, the digital object marketplace can require each user to link a digital wallet to the digital object marketplace. The digital wallet may be required for the management of various cryptographic tokens (e.g., object owner tokens, object license tokens, etc.), processing of payments for cryptographic tokens, and to receive automated payments associated with the purchase of object license tokens for a digital object by licensees and with financial distributions earned as a result of the sale of media license tokens corresponding to digital media that includes digital objects subject to pre-defined financial distribution terms. In an embodiment, the digital wallet is a software-based cryptocurrency wallet that is used to interact with a decentralized distributed ledger. The digital wallet may be made accessible via a browser extension application 514 executed when a user accesses a corresponding browser application 500 on their computing device. In an embodiment, when a user attempt to publish a digital object to the digital object marketplace utilizing its browser application 500, the digital object marketplace may attempt to access the browser extension application 514 for authentication of the user and to link the user's account within the digital object marketplace with its digital wallet. An identifier 502 corresponding to this digital wallet and the user may be presented via the website or web portal provided by the digital object marketplace displayed via the browser application 500.

In addition to deploying a smart contract for the digital object to the decentralized distributed ledger, the digital object marketplace may further store the digital object in a digital object store within a distributed file system. Further, when the smart contract corresponding to the published digital object is deployed to the decentralized distributed ledger, the smart contract may generate an object owner token that designates the content creator as the originator of the digital object. The object owner token may be issued and held by the content creator in its digital wallet and recorded in the decentralized distributed ledger. Alternatively, the smart contract may indicate an address corresponding to a recipient digital wallet to which any financial distributions corresponding to sales of the digital object or other media that incorporates the digital object may be deposited. The recipient digital wallet may correspond to the content creator's digital wallet.

The smart contract may also generate the object license tokens for the published digital object. The object license tokens may be generated automatically when the smart contract is deployed to the decentralized distributed ledger and provided to the digital wallet owned and maintained by the digital object marketplace on behalf of the content creator. When a licensee purchases a license to the digital object via the digital object marketplace, the digital object marketplace may automatically transfer an object license token from its digital wallet to the digital wallet of the licensee. This transaction may be recorded in the decentralized distributed ledger. In an embodiment, an object license token can be generated at the point-of-sale (e.g., when the licensee submits a request to purchase a license to the digital object) by the smart contract and automatically transferred to the licensee's digital wallet.

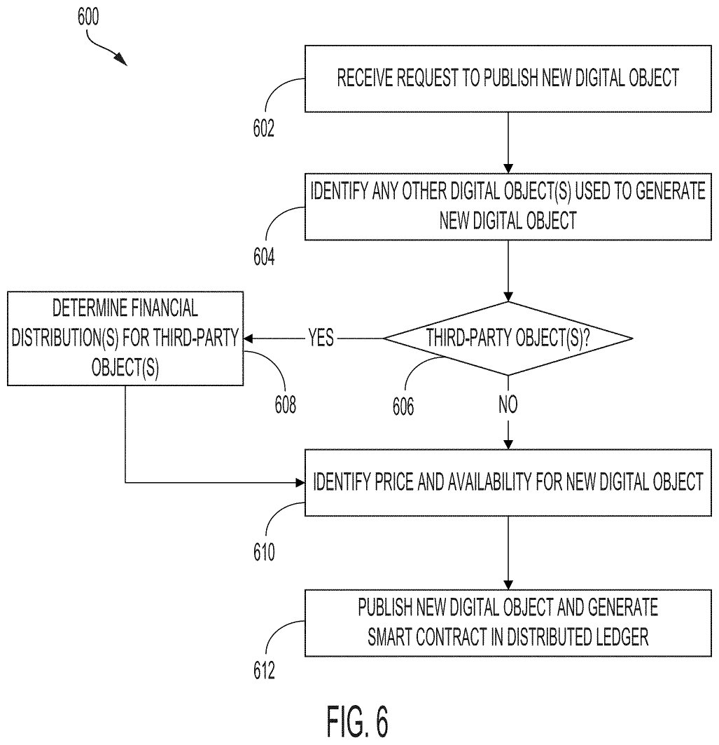

FIG. 6 shows an illustrative example of a process 600 for publishing a new digital object and establishing a smart contract in a distributed ledger for licensing of the new digital object in accordance with at least one embodiment. The process 600 may be performed by an object publishing system of the digital object marketplace, such as object publishing system 204 illustrated and described herein in connection with FIG. 2. Further, the process 600 may be performed in conjunction with a decentralized distributed ledger that may be used to deploy a smart contract for a new digital object as described herein.

At step 602, the object publishing system may receive a request to publish a new digital object. The new digital object may be a standalone digital object, such as a motion capture file, a sound recording, and the like. Alternatively, the new digital object may include new digital media created using various digital objects (e.g., a video game, etc.) from other content creators associated with the digital object marketplace. The request to publish the new digital object may specify one or more parameters corresponding to the new digital object. For instance, the one or more parameters may include a price for purchase of a license token to the digital object, financial distribution terms for purchases of any digital media that uses the digital object as a component, terms or policies for how the digital object may be used by licensees, the number of license tokens that may be generated and issued for the digital object, and the like. In an embodiment, a content creator, via the digital object marketplace, can define a bonding curve, which may be used by the digital object marketplace to automatically, and in real-time, adjust the price for a license token based on the supply of available license tokens for the digital object, as described above. Further, a content creator can define individual licensing terms for specific licensees seeking to purchase a license token for its digital object. For example, a content creator may define specific financial distribution terms for different licensees, whereby a certain licensee may be subject to higher financial distribution requirements compared to other licensees. In some instances, the content creator may define one or more formulas by which financial distribution terms may be automatically defined based on the upfront payment made by a licensee to purchase a license token for a digital object, as described above.

At step 604, the object publishing system may identify any other digital objects utilized by the content creator to generate the new digital object being published. As noted above, a content creator may generate a new digital object via a media development environment provided by the digital object marketplace. Through this media development environment, a content creator may upload digital objects and access any licensed digital objects for use in the media development environment to generate new digital media (e.g., video games, digital images, digital video, digital audio, etc.). In an embodiment, when the independent developer ports a digital object represented by an object license token into their media development environment, the digital object marketplace may refer to the content creator's digital wallet to determine whether the independent developer has the requisite object license token for the digital object. If the digital object marketplace determines that the independent developer has the requisite object license token for the digital object, the digital object marketplace may further determine whether the independent developer may utilize the digital object for the new digital media being developed in the media development environment. Through this process of introducing digital objects into the media development environment, the digital object marketplace may identify any other digital objects used to generate the new digital object being published.

At step 606, the object publishing system may determine whether any of these other digital objects are third-party objects (e.g., are associated with object owner tokens issued to other content creators, are associated with recipient digital wallets corresponding to the other content creators, etc.). If the new digital object that is to be published includes any third-party objects, the object publishing system, at step 608, may determine any financial distribution schemas for these third-party objects. As noted above, a digital object published to the digital object marketplace may be associated with a smart contract, which may be deployed to the decentralized distributed ledger, where the smart contract may reside at a specific address on the decentralized distributed ledger. The smart contract may serve as a type of account within the decentralized distributed ledger, whereby the smart contract may have a balance and may transmit transactions over a decentralized network. Further, the smart contract may function as programmed by the object publishing system. For instance, when users interact with an object licensing system to obtain an object license token for the digital object, the object licensing system may interact with the smart contract by submitting transactions on behalf of users that execute one or more functions defined in the smart contract. The smart contract may define the financial distribution terms for a third-party object, such that payments made for the licensing of the new digital object may be divided such that a portion of these payments is made to the holder of the object owner token or owner of the recipient digital wallet for the third-party object according to the financial distribution terms defined in the smart contract for the third-party object. Thus, the object publishing system may reference the smart contracts for the third-party objects to determine the financial distributions for these third-party objects.

At step 610, the object publishing system may identify the price and availability for the new digital object. For instance, the request to publish the new digital object may specify a particular price for the new digital object, either using units associated with a cryptocurrency or with a fiat currency. Further, the request may specify a maximum number of license tokens that may be made available for the digital object. In some instances, the price may be defined using a bonding curve tied to the availability for the new digital object, whereby the price for a license token may dynamically and in real-time vary according to the number of remaining available license tokens for the digital object.

At step 612, the object publishing system may publish the new digital object and generate a smart contract that can be deployed to the decentralized distributed ledger to make the digital object available for purchase via the digital object marketplace. For instance, the object publishing system may map the purchase price and financial distribution terms (if any) to a smart contract corresponding to the digital object. The smart contract, as noted above, may be deployed to the decentralized distributed ledger, where the smart contract may reside at a specific address on the decentralized distributed ledger. When the smart contract corresponding to the published digital object is deployed to the decentralized distributed ledger, the smart contract may generate an object owner token that designates the content creator as the originator of the digital object. The object owner token may be issued and held by the content creator in its digital wallet and recorded in the decentralized distributed ledger. Alternatively, when the smart contract is deployed, the smart contract may designate a recipient digital wallet that may be associated with the content creator.

As noted above, the object owner token may be transferrable to other users of the digital object marketplace. Transfers of the object owner token may be processed using the decentralized distributed ledger and recorded therein. The other user, now the holder of the object owner token, may automatically, and in real-time, receive any payments generated through the sale of license tokens associated with the digital object and any financial distributions generated by the license tokens linked to the object owner token. In a similar fashion, the recipient digital wallet may be transferred to another entity through modification of the smart contract. For instance, the address corresponding to the recipient digital wallet specified in the smart contract may be modified to correspond to the digital wallet of the other entity to which ownership of the digital object was transferred.

The smart contract deployed to the decentralized distributed ledger may further generate the one or more license tokens that may be made available for licensing of the digital object. The object license tokens may be generated automatically when the smart contract is deployed to the decentralized distributed ledger and provided to a digital wallet owned and maintained by an object licensing system of the digital object marketplace on behalf of the content creator. Alternatively, the license tokens can be generated on demand, such as in response to a request to purchase a license token for the digital object via the digital object marketplace.

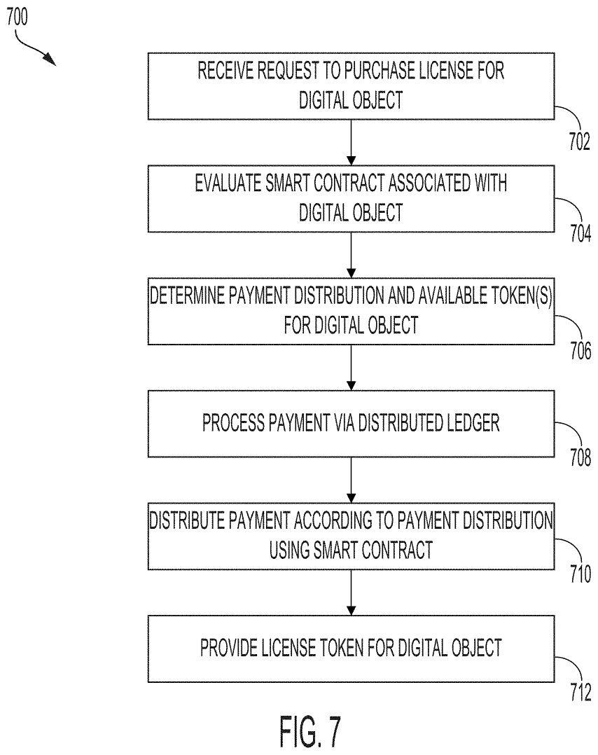

FIG. 7 shows an illustrative example of a process 700 for issuing a license token for a digital object and automatically distributing payments to corresponding content creators using a smart contract in accordance with at least one embodiment. The process 700 may be performed by an object licensing system of the digital object marketplace, such as object licensing system 206 described above in connection with FIG. 2. Further, the process 700 may be performed in conjunction with a smart contract deployed in a decentralized distributed ledger and associated with the digital object for which a license is being purchased as described herein.

At step 702, the object licensing system may receive a request to purchase a license token for a digital object. For instance, a user of the digital object marketplace may access a landing page for a digital object and submit a request to purchase a license token for the particular digital object. The digital object, as noted above, may be standalone component (e.g., motion capture file, sound recording, icon, image, etc.) or a digital media (e.g., a video game, digital image, digital video, digital audio, etc.).

At step 704, the object licensing system may evaluate the smart contract deployed to the decentralized distributed ledger and associated with the particular digital object for which the license token is being obtained. As noted above, a smart contract for a digital object may serve as a type of account within the decentralized distributed ledger, whereby the smart contract may have a balance and may transmit transactions over a decentralized network. Further, the smart contract may function as programmed by the object publishing system. For instance, when users interact with an object licensing system to obtain an object license token for the digital object, the object licensing system may interact with the smart contract by submitting transactions on behalf of users that execute one or more functions defined in the smart contract. The smart contract may indicate the number of available license tokens for the digital object, as well as the distribution chain for payments associated with the purchase of a license token. For instance, a digital object may be generated using one or more other digital objects subject to a set of financial distribution terms. The smart contract for the digital object may utilize the financial distribution terms for these one or more other digital objects to determine the distribution of a payment made for the purchase of a license token for the digital object.

At step 706, the object licensing system, via the smart contract for the digital object, may determine the payment distribution and available license tokens for the digital object. As noted above, the smart contract for the digital object may make reference to other smart contracts associated with other digital objects used to create the digital object and for which financial distribution terms have been defined. Through these other smart contracts, the smart contract may determine a distribution schema for payments made for the purchase of a license token for the digital object. This distribution schema may define percentages or fixed amounts of a payment that are to be distributed to other content creators (e.g., holders of object owner tokens or owners of recipient digital wallets for any other digital objects subject to financial distribution terms). In addition to defining a distribution schema for payments made for purchases of licensing tokens for the digital object, a smart contract can further specify the maximum number of licensing tokens generated and made available for the digital object. For instance, a content creator, when publishing the digital object to the digital object marketplace, may define the number of licensing tokens that may be made available for the digital object. Thus, from the smart contract, the object licensing system may determine the number of available licensing tokens and, if a bonding curve is defined for determining the price of a license token, the price for the license token.

At step 708, the object licensing system, in conjunction with the smart contract for the digital object, may process the licensee's payment via the decentralized distributed ledger. For instance, the object licensing system may transmit a payment request to a payment processing system of the digital object marketplace for processing and distribution of the user's payment to the content creator according to the financial distribution terms specified in the smart contract. The payment processing system may transmit the transaction request, either the owner token held by the content creator or independent developer of the digital object or the address of the recipient digital wallet owned by the content creator or independent developer, and an identity token corresponding to the purchaser's digital wallet to the smart contract for the digital object deployed in the decentralized distributed ledger for processing of the transaction. The smart contract, at step 710, may distribute the payment according to the financial distribution schema specified therein. For instance, the smart contract may transfer portions of the payment to the digital wallets of the content creators associated with the digital object (e.g., the content creator that published the digital object and any other content creators whose digital objects were utilized to generate the digital object) according to the defined financial distribution schema. The payment may be processed from the purchaser's digital wallet and the transaction may be recorded in the decentralized distributed ledger. Further, at step 712, the smart contract may transfer a license token to the purchaser's digital wallet to complete the transaction.

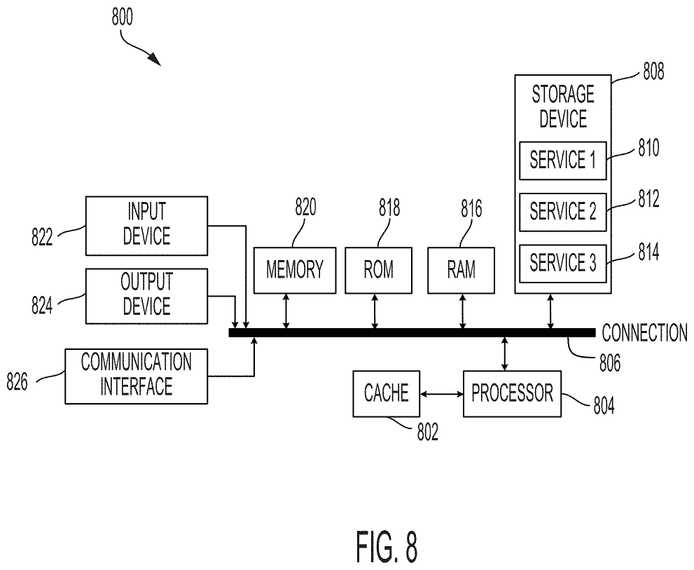

FIG. 8 illustrates a computing system architecture 800 including various components in electrical communication with each other using a connection 806, such as a bus, in accordance with some implementations. Example system architecture 800 includes a processing unit (CPU or processor) 804 and a system connection 806 that couples various system components including the system memory 820, such as ROM 818 and RAM 816, to the processor 804. The system architecture 800 can include a cache 802 of high-speed memory connected directly with, in close proximity to, or integrated as part of the processor 804. The system architecture 800 can copy data from the memory 820 and/or the storage device 808 to the cache 802 for quick access by the processor 804. In this way, the cache can provide a performance boost that avoids processor 804 delays while waiting for data. These and other modules can control or be configured to control the processor 804 to perform various actions.

Other system memory 820 may be available for use as well. The memory 820 can include multiple different types of memory with different performance characteristics. The processor 804 can include any general purpose processor and a hardware or software service, such as service 1 810, service 2 812, and service 3 814 stored in storage device 808, configured to control the processor 804 as well as a special-purpose processor where software instructions are incorporated into the actual processor design. The processor 804 may be a completely self-contained computing system, containing multiple cores or processors, a bus, memory controller, cache, etc. A multi-core processor may be symmetric or asymmetric.

To enable user interaction with the computing system architecture 800, an input device 822 can represent any number of input mechanisms, such as a microphone for speech, a touch-sensitive screen for gesture or graphical input, keyboard, mouse, motion input, speech and so forth. An output device 824 can also be one or more of a number of output mechanisms known to those of skill in the art. In some instances, multimodal systems can enable a user to provide multiple types of input to communicate with the computing system architecture 800. The communications interface 826 can generally govern and manage the user input and system output. There is no restriction on operating on any particular hardware arrangement and therefore the basic features here may easily be substituted for improved hardware or firmware arrangements as they are developed.

Storage device 808 is a non-volatile memory and can be a hard disk or other types of computer readable media which can store data that are accessible by a computer, such as magnetic cassettes, flash memory cards, solid state memory devices, digital versatile disks, cartridges, RAMs 816, ROM 818, and hybrids thereof. In some aspects, storage device 808 can be implemented and reside in a cloud (in physical and/or virtual form), which may include one or more cloud components in one or more networks, distributed ledger-based computing in a cloud, and the like.

The storage device 808 can include services 810, 812, 814 for controlling the processor 804. Other hardware or software modules are contemplated. The storage device 808 can be connected to the system connection 806. In one aspect, a hardware module that performs a particular function can include the software component stored in a computer-readable medium in connection with the necessary hardware components, such as the processor 804, connection 806, output device 824, and so forth, to carry out the function.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks, distributed ledger-based computing in a cloud, and the like. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving a request to obtain a license token for a digital object, wherein license tokens for the digital object are generated by a smart contract deployed in a distributed ledger, wherein the license tokens allow access to the digital object, and wherein the digital object is associated with a digital wallet corresponding to a creator of the digital object;
transferring a payment from a digital wallet associated with the request to the digital wallet corresponding to the creator of the digital object, wherein the payment is transferred by the smart contract, and wherein the payment is recorded in the distributed ledger; and
providing the license token for the digital object to the digital wallet associated with the request, wherein a transaction providing the license token for the digital object to the digital wallet associated with the request is recorded in the distributed ledger.

2. The computer-implemented method of claim 1, wherein the payment is provided using a cryptocurrency, wherein the cryptocurrency corresponds to the distributed ledger.

3. The computer-implemented method of claim 1, wherein:
the digital object includes one or more other digital objects, wherein inclusion of the one or more other digital objects is subject to a set of financial distribution terms; and
the computer-implemented method further comprises transferring payments from the digital wallet associated with the request to digital wallets corresponding to creators of the one or more other digital objects, wherein the payments are determined according to the set of financial distribution terms.

4. The computer-implemented method of claim 1, wherein the payment is determined in real-time according to a bonding curve for the digital object, wherein the bonding curve defines a price for the license token according to a number of remaining license tokens for the digital object.

5. The computer-implemented method of claim 1, wherein:
the payment is provided using a fiat currency; and
the computer-implemented method further comprises converting the payment in real-time to a cryptocurrency, wherein the cryptocurrency corresponds to the distributed ledger.

6. The computer-implemented method of claim 1, wherein the digital object is maintained in a distributed file system.

7. The computer-implemented method of claim 1, wherein the digital object is associated with a transferrable owner token stored in the digital wallet corresponding to the creator of the digital object, wherein when the transferrable owner token is transferred to another digital wallet, payments submitted to purchase the license tokens for the digital object are automatically provided to the other digital wallet.

8. A system, comprising:
one or more processors; and
memory storing thereon instructions that, as a result of being executed by the one or more processors, cause the system to:
receive a request to obtain a license token for a digital object, wherein license tokens for the digital object are generated by a smart contract deployed in a distributed ledger, wherein the license tokens allow access to the digital object, and wherein the digital object is associated with a digital wallet corresponding to a creator of the digital object;
transfer a payment from a digital wallet associated with the request to the digital wallet corresponding to the creator of the digital object, wherein the payment is transferred by the smart contract, and wherein the payment is recorded in the distributed ledger; and
provide the license token for the digital object to the digital wallet associated with the request, wherein a transaction providing the license token for the digital object to the digital wallet associated with the request is recorded in the distributed ledger.

9. The system of claim 8, wherein the payment is provided using a cryptocurrency, wherein the cryptocurrency corresponds to the distributed ledger.

10. The system of claim 8, wherein:
the digital object includes one or more other digital objects, wherein inclusion of the one or more other digital objects is subject to a set of financial distribution terms; and
the instructions further cause the system to transfer payments from the digital wallet associated with the request to digital wallets corresponding to creators of the one or more other digital objects, wherein the payments are determined according to the set of financial distribution terms.

11. The system of claim 8, wherein the payment is determined in real-time according to a bonding curve for the digital object, wherein the bonding curve defines a price for the license token according to a number of remaining license tokens for the digital object.

12. The system of claim 8, wherein:
the payment is provided using a fiat currency; and
the instructions further cause the system to convert the payment in real-time to a cryptocurrency, wherein the cryptocurrency corresponds to the distributed ledger.

13. The system of claim 8, wherein the digital object is maintained in a distributed file system.

14. The system of claim 8, wherein the digital object is associated with a transferrable owner token stored in the digital wallet corresponding to the creator of the digital object, and wherein when the transferrable owner token is transferred to another digital wallet, payments submitted to purchase the license tokens for the digital object are automatically provided to the other digital wallet.

15. A non-transitory, computer-readable storage medium storing thereon executable instructions that, as a result of being executed by one or more processors of a computer system, cause the computer system to:
receive a request to obtain a license token for a digital object, wherein license tokens for the digital object are generated by a smart contract deployed in a distributed ledger, wherein the license tokens allow access to the digital object, and wherein the digital object is associated with a digital wallet corresponding to a creator of the digital object;
transfer a payment from a digital wallet associated with the request to the digital wallet corresponding to the creator of the digital object, wherein the payment is transferred by the smart contract, and wherein the payment is recorded in the distributed ledger; and
provide the license token for the digital object to the digital wallet associated with the request, wherein a transaction providing the license token for the digital object to the digital wallet associated with the request is recorded in the distributed ledger.

16. The non-transitory, computer-readable storage medium of claim 15, wherein the payment is provided using a cryptocurrency, wherein the cryptocurrency corresponds to the distributed ledger.

17. The non-transitory, computer-readable storage medium of claim 15, wherein:
the digital object includes one or more other digital objects, wherein inclusion of the one or more other digital objects is subject to a set of financial distribution terms; and
the executable instructions further cause the computer system to transfer payments from the digital wallet associated with the request to digital wallets corresponding to creators of the one or more other digital objects, wherein the payments are determined according to the set of financial distribution terms.

18. The non-transitory, computer-readable storage medium of claim 15, wherein the payment is determined in real-time according to a bonding curve for the digital object, wherein the bonding curve defines a price for the license token according to a number of remaining license tokens for the digital object.

19. The non-transitory, computer-readable storage medium of claim 15, wherein:
the payment is provided using a fiat currency; and
the executable instructions further cause the computer system to convert the payment in real-time to a cryptocurrency, wherein the cryptocurrency corresponds to the distributed ledger.

20. The non-transitory, computer-readable storage medium of claim 15, wherein the digital object is maintained in a distributed file system.

21. The non-transitory, computer-readable storage medium of claim 15, wherein the digital object is associated with a transferrable owner token stored in the digital wallet corresponding to the creator of the digital object, and wherein when the owner token is transferred to another digital wallet, payments submitted to purchase the license tokens for the digital object are automatically provided to the other digital wallet.
